(19) United States
(12) Patent Application Publication
(10) Pub. No.: US 2014/0065283 A1
(43) Pub. Date: Mar. 6, 2014

(54) Confectionery Coating Fat with Low Saturated Fat

(71) Applicant: AarhusKarlshamn USA Inc., Edison, NJ (US)

(72) Inventors: Jeffrey B. Fine, Livingston, NJ (US); Jessica A. Blackford, Maplewood, NJ (US); Sarah A. Teichert, Piscataway, NJ (US); Binu Z. Eapen, New Milford, NJ (US)

(73) Assignee: AarhusKarlshamn USA Inc., Edison, NJ (US)

(21) Appl. No.: 14/016,902

(22) Filed: Sep. 3, 2013

Related U.S. Application Data
(60) Provisional application No. 61/696,243, filed on Sep. 3, 2012.

(51) Int. Cl. A23G 3/40; A23D 9/007

(52) U.S. Cl. CPC A23G 3/40; A23D 9/007
USPC 426/607

(57) ABSTRACT

Disclosed are compositions for confectionery coating fat compositions, wherein the coatings exhibit good coating properties yet have very low saturated fat contents, very high unsaturated fat contents and low trans contents. The confectionery coating fat compositions of the invention can be used alone or in blends to have 35 to 80%, e.g., 70% or less, saturated fatty acids for preparing confectionery coating compositions comprising sugar and flavor that exhibit good snap. The confectionery coating fat compositions are blends of a structuring agent, e.g., from about 35 to about 80%, with liquid oil in an amount of from about 20 to 65%. In some products the structuring agent can comprise an interesterified blend of palm stearine, e.g., from about 30 to 75%, of low iodine value and from palm kernel stearine, e.g., from about 25 to 70%, also of low iodine value. The structural fat can contain at least 90% of the saturated fatty acids present as lauric, myristic, palmitic and stearic acids. Fat blends including the confectionery coating fat compositions can include melt-enhancing or heat stability enhancing fats in amounts necessary to achieve the effect of the added fats.

### PRIORITY CLAIM

This application claims priority to copending U.S. Provisional application Ser. No. 61/696,243, filed Sep. 3, 2012, which is incorporated herein in its entirety.

### FIELD OF THE INVENTION

The invention relates generally to confectionery fat compositions suitable for confectionery coatings, wherein the fats have low saturated fat contents and high unsaturated fat contents, yet exhibit properties including rapid set up to structurally stable form, enabling their use in a wide variety of coating applications.

### BACKGROUND OF THE INVENTION

Typically, confectionery coating fats have high saturated fat contents to give them expected properties, including rapid set up with good structural integrity and freedom from smearing and oil-off at room temperature. Large amounts of triglycerides containing saturated and trans fatty acids and only small amounts of unsaturated fatty acids have been thought necessary to achieve good coating performance. These fats have steep melting profiles starting with high solids contents at room temperature (defined herein as 20° C.) and sharply lose solids as temperature is increased to just under body temperature (defined herein as 35° C.) to provide a pleasing mouthfeel and flavor release.

While a good coating fat is expected to exhibit these properties, the compositions that achieve them are not seen in a favorable light nutritionally due to the presence of high levels of saturated and/or trans fats. Experts generally agree that both saturated fats and those containing trans unsaturation should be reduced in the human diet. For example, Key Recommendations cited in the Executive Summary of the Dietary Guidelines for Americans 2010 (U.S. Department of Agriculture U.S. Department of Health and Human Services; available at www.dietaryguidelines.gov) identify several foods and food components to reduce. Out of seven recommendations, they make the following three regarding fats: (1) consume less than 10 percent of calories from saturated fatty acids by replacing them with monounsaturated and polyunsaturated fatty acids; (2) keep trans fatty acid consumption as low as possible by limiting foods that contain synthetic sources of trans fats, such as partially hydrogenated oils, and by limiting other solid fats; and (3) reduce the intake of calories from solid fats and added sugars.

While these are admirable goals for nutrition, they are largely inconsistent with current confectionery coating fat technology. Confectionery coating fats that fare well at ambient temperature conditions have not been possible heretofore without large amounts of saturated and/or trans unsaturated fats. Without the saturated and/or trans fats in high proportions, coatings tend to lack structural rigidity and often smudge or oil off. The term “coating fat composition” is generally understood to refer to a composition that can be suitably employed to provide foodstuffs with a coating that has structural integrity and does not smudge or oil off at ambient temperature.

The gold standard for confectionery coating fat compositions is cocoa butter. Cocoa butter is rich in symmetrical monounsaturated triglycerides, e.g., palmitic-oleic-palmitic (POP), palmitic-oleic-stearic (POSt), stearic-oleic-stearic (StOSt), which are necessary to give cocoa butter a very steep melting curve. They are also responsible for cocoa butter being polymorphic and, consequently, needing tempering.

Cocoa butter is thus high in saturated fatty acids and is relatively expensive. Efforts have been intense over many years to find alternatives, and the art has developed a variety of alternative confectionery coating fat compositions, among which are cocoa butter equivalents (CBE), cocoa butter replacers (CBR), and cocoa butter substitutes (CBS). Each of these has been adopted by the art with a specific meaning. Unfortunately, they remain high in saturated and/or trans unsaturated fatty acid content.

Cocoa butter equivalents are fats which have chemical and physical properties compatible with cocoa butter, and can be used to supplement or replace cocoa butter in confectionery products. A typical saturated fat content of a CBE is 60%. Cocoa butter replacers are non-tempering fats, which can contain on the order of 50% trans fat and are only partially compatible with cocoa butter. CBR are typically created from non-lauric fats which have been partially hydrogenated under trans-promoting conditions to build structure in the oil and give relatively steep melting curves. Cocoa butter substitutes are generally lauric fats which are largely incompatible with cocoa butter. Typically containing about 95% saturated fat, cocoa butter substitutes are non-tempering, generally less expensive than cocoa butter and are used widely in confectionery applications, such as coatings and fillings. It would be desirable to have cocoa butter alternatives that are non-tempering, easy to use in conventional processing equipment and provide acceptable chocolate-like properties making them suitable as confectionery coating fats, while not being restricted to generally-accepted formulation criteria that require high saturated and/or trans fat contents.

A challenge we have been presented with, and one common to all confectionery coating fats, is that they have depended upon triglycerides high in saturates and have been characterized by large amounts of triglycerides containing largely saturated fatty acids and lesser amounts of unsaturated fatty acids. They, like cocoa butter, tend to exhibit steep melting profiles starting with high solids contents at room temperature and sharply lose solids near body temperature as illustrated by the curves for Fat A and Fat B in FIG. 1.

There is a present need for confectionery coating fat compositions and processes for making and using them, wherein the coatings exhibit properties suitable for confectionery coatings yet have low saturated and trans fatty acid contents and high unsaturated fatty acid contents to enable consumers to eat confectionery products without concern for negative health effects.

### SUMMARY OF THE INVENTION

The need for a low-saturated and low-trans fat having the ability to rapid set up to a structurally stable form is achieved by the present invention, which provides compositions for confectionery coating fat compositions and processes for making and using them, wherein the coatings exhibit properties important to coatings, e.g., rapid set up to structurally stable form, and good appearance such as gloss, while not being restricted to generally-accepted formulation criteria that require high saturated fat contents and/or high trans fat contents. Coating fats with as little as 35% saturated fatty acid content are provided by the invention.

Embodiments of the invention provide fat compositions characterized by rapid set up times to achieve a structurally-stable form. When formulated into confectionery coating compositions, e.g., comprised of fat, cocoa powder, sugar and emulsifier, some coatings will set up sufficiently to enable packaging in the same manner as conventional, high saturated fat coatings, e.g., in twenty minutes or less under cooling conditions (for example: 10° C.). These properties are unusual properties for compositions based on fats having low contents of saturated and trans fatty acids and high contents of unsaturated fatty acids.

Embodiments of the invention provide fat compositions characterized by viscosities that increase rapidly upon cooling. In a typical confectionery coating, the fat is the continuous phase of the product. A critical amount of the structure of the coating is dependent on the structure and rigidity contributed by the coating fat. At the same time, the coating fat must have a suitably low melting point for pleasing mouthfeel and flavor release during the consumption of the coating. These two attributes, rigidity/structure and a melt near to body temperature, were previously only known to be a characteristic of highly-saturated and/or high-trans content hard butters (e.g., about 66% SAFA (saturated fatty acids) in cocoa butter and about 95% SAFA in CBS). The important property of rapid set up to structural integrity at ambient temperature is unusual for fats having low contents of saturated and trans fatty acids and high contents of natural, cis-unsaturated fatty acids.

Embodiments of the invention provide fat compositions, which exhibit crystallization rates that are unusual for fats having low contents of saturated and trans fatty acids and high contents of unsaturated fatty acids and do not need to be tempered in distinction to CBEs and cocoa butter.

Embodiments provide processing efficiencies and improved products due to these properties.

Among the confectionery coating compositions of the invention are those that can be applied in a molten form and cooled to rapidly set them to a consistency suitable for packaging.

Among the coating compositions of the invention are those, which when used as a coating or molded and tested in shapes typical of chocolate bars, have the structure and rigidity of conventional products and exhibit good snap, in some embodiments similar to a commercial milk chocolate bar. These compositions, like others of the invention, have low saturated fat contents and high unsaturated fat contents.

In one preparation, a confectionery coating fat composition for preparing coatings that exhibit rapid set up to a structurally integral form, comprise a blend of: a structuring agent comprising an interesterified blend of palm stearine and palm kernel stearine; and a liquid triglyceride oil; wherein, when the confectionery coating fat composition is formulated into a confectionery coating.

In embodiments, the structuring agent can be employed as a minor component relative to the liquid triglyceride oil, and the saturated fatty acids can comprise a minor component of the total confectionery coating fat composition.

In an embodiment, the structuring agent can comprise from 35 to 80%, preferably from 40 to 65%, of the total confectionery coating fat composition.

In an embodiment, a confectionery coating fat composition will include from 20 to 65%, preferably 35 to 60% of a liquid triglyceride oil.

In embodiments, the saturated fatty acids can comprise from 35 to 80%, e.g., from 40 to 70%, of the total confectionery coating fat composition. It is an advantage that some embodiments will contain less than 60% saturated fatty acids.

In embodiments, at least 90% of the saturated fatty acids in the confectionery fat composition will be present as lauric, myristic, palmitic and stearic acids. In some embodiments the structuring agent will comprise less than 10% stearic acid, e.g., less than 5%.

In an embodiment, a structuring agent will comprise an interesterified blend of palm stearine and palm kernel stearine, wherein the blend contains at least 90% of the saturated fatty acids present as lauric, myristic, and palmitic acids.

From another perspective, an embodiment of the invention will comprise a blend of: from 35 to 80% of a structuring agent comprising an interesterified blend of from 30 to 75% of palm stearine having a low iodine value, e.g., of less than about 15, and from 25 to 70% palm kernel stearine having a low iodine value, e.g., of less than about 10.

And, in embodiments a liquid triglyceride oil having a saturated fatty acid content of less than 10%. In some less than 8% polyunsaturated fatty acids will be employed. In some embodiments at least 92% of the fatty acids in the liquid oil will be present as cis-unsaturated fatty acids.

From still another perspective, a liquid triglyceride oil comprises one or more selected from the group consisting of Canola oil, corn oil, cottonseed oil, marine oils, meadowfoam oil, mustard seed oil, olive oil, peanut oil, poppy seed oil, rice bran oil, safflower oil, sesame, soybean oil, high oleic soybean oil, sunflower oil, high oleic sunflower oil, low melting fractions of fats such as babassu nut oil, palm oil, palm kernel oil, tallow, lard, shea butter, milk fat, and the like.

In some embodiments, melt-enhancing fats, which are distinguished from the liquid triglyceride oils as having a melt point above 20° C., will comprise up to 70%, e.g., 20 to 55%, of some confectionery fat blends made with the confectionery coating fat compositions of the invention. Among the suitable melt enhancing fats are one or more members selected from the group consisting of: palm kernel hard fractions, palm oil hard fractions, hydrogenated coconut oil, hydrogenated palm kernel oil, hydrogenated palm kernel hard fractions, and the like. Desirably, hydrogenated fats employed as melt enhancing fats should contain low amounts of trans fats (e.g., less than about 2%). The addition of these melt-enhancing fats in some embodiments can improve flavor release and/or meltaway properties and/or improve structural integrity for some confectionery coating applications.

In embodiments, other functional additives may be employed in minor amounts to improve heat stability, e.g., comprising up to about 6% of the total confectionery coating fat composition. Palm stearine with an IV of less than 15, an interesterified blend of shea stearine and palm stearine, hydrogenated palm oil hard fractions, and diglycerides can increase heat stability of confectionery coatings.

In another aspect, the invention provides a process for preparing a confectionery coating fat composition for preparing coatings, comprising: obtaining a confectionery fat comprised of a liquid oil and a structuring fat as defined, and blending the confectionery fat into a confectionery coating, which typically can contain sugar, optional cocoa powder, emulsifier and flavoring, all in reasonable proportions.

Other and preferred aspects of the invention are described below.

### DESCRIPTION OF THE DRAWINGS

The accompanying drawings, which are incorporated in and constitute a part of this description, illustrate aspects of the invention, and together with the detailed description of the embodiments given below, serve to explain the invention and how to practice it in practical ways.

FIG. 1 is a graph of the melting characteristics of three coating fats, Fats A and B are commercially-available products, and Fat C is one formulation prepared according to the invention.

FIG. 2 is a graph of the crystallization rate as measured by solid fat content in coating fats and compares a fat of the invention (--▴--) containing only 40% saturated fatty acids versus a commercial fat (--▪--) with about 98% saturates.

FIG. 3 is a graph similar to FIG. 1 of the melting characteristics of fats prepared according to the Examples below, wherein the fat of Example 1 is shown by the line with the (--×--) symbol, the fat of Example 2 is shown by the line with the (--▴--) symbol, the fat of Example 3 is shown by the line with the (--♦--) symbol, and the fat of Example 4 is shown by the line with the (--▪--) symbol and the fat blend of Example 5 is shown by the line with the (-- [symbol] --) symbol.

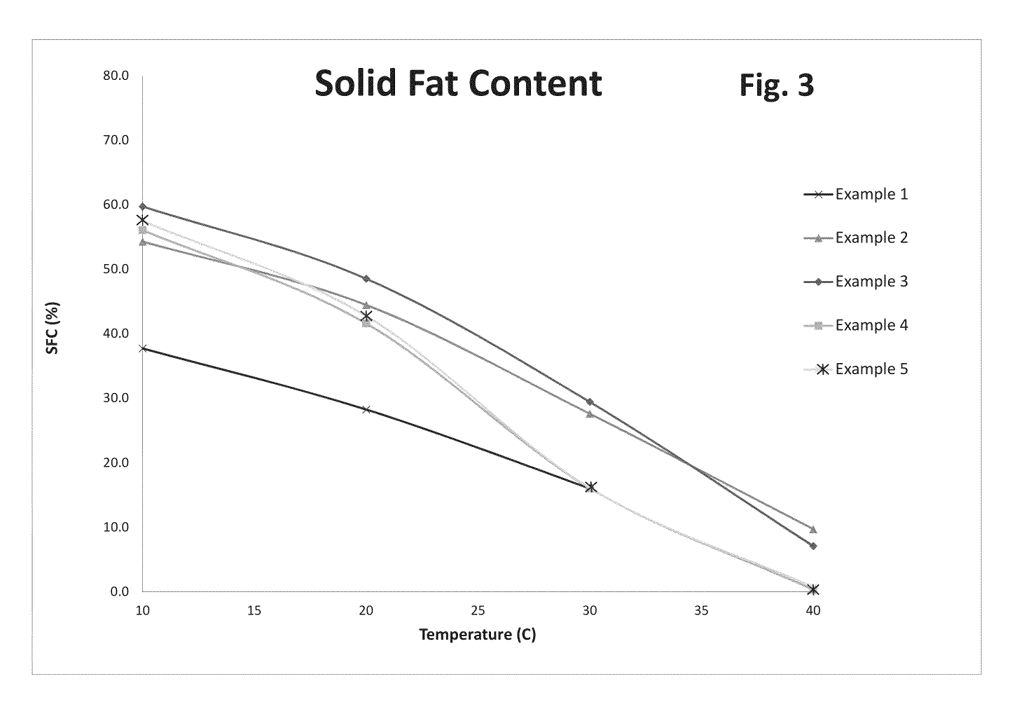

### DETAILED DESCRIPTION OF THE INVENTION

In describing the present invention, reference is made to the drawings and to the examples where a number of products and processes are specifically described and exemplified.

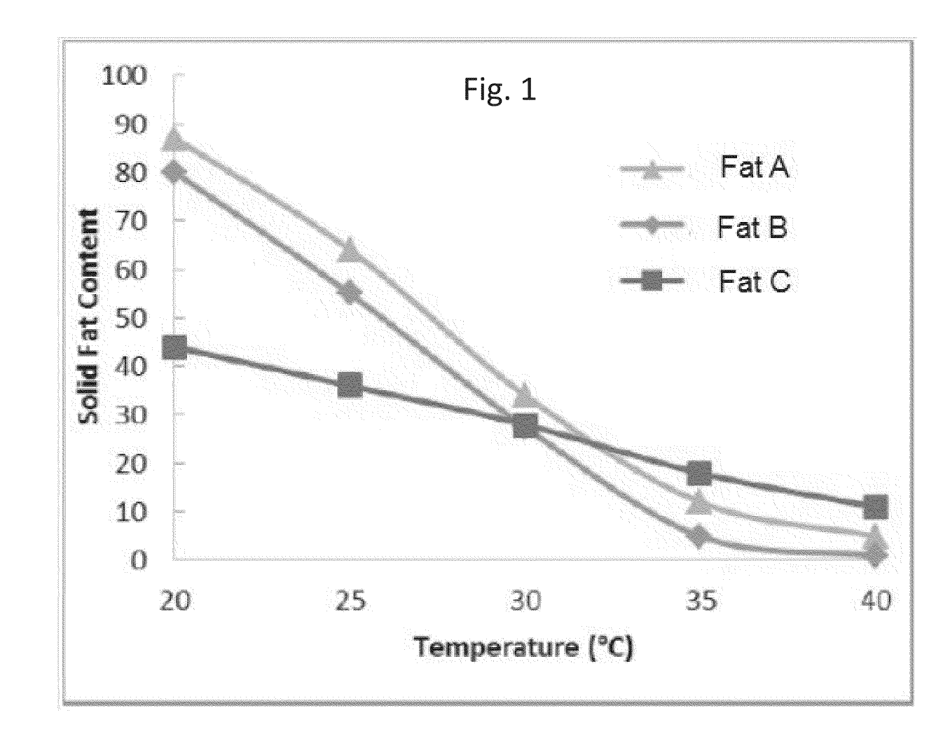

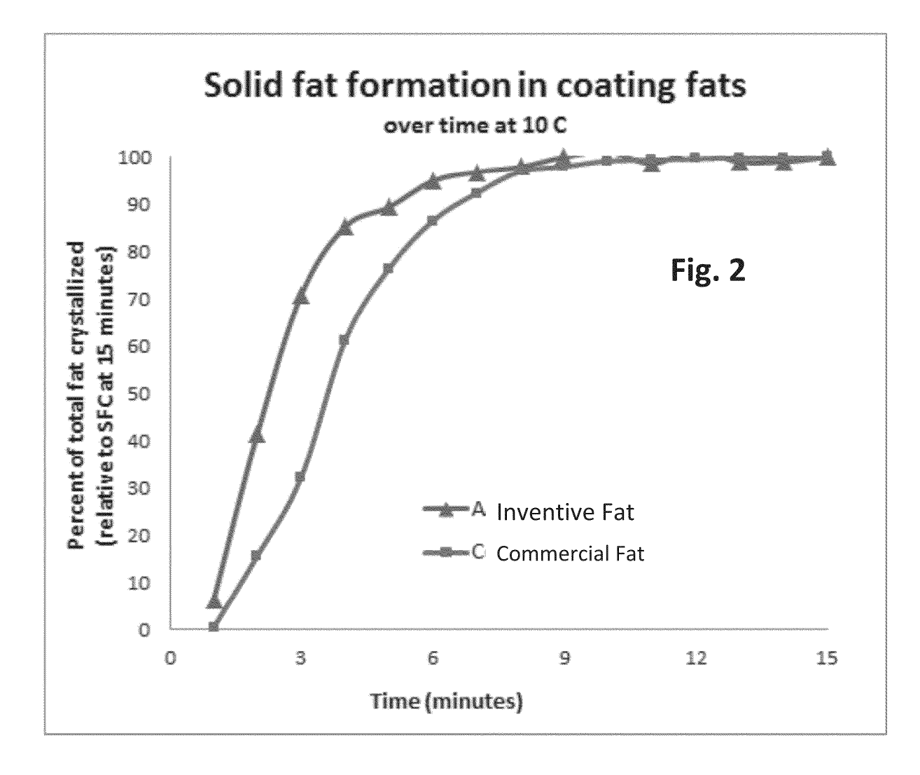

The invention involves preparing coating fat compositions that surprisingly redefine compositional characteristics of coating fats without adversely affecting the properties that are most important. Importantly, the confectionery fat compositions of the invention and coatings made from them will set up rapidly to achieve structural integrity while being distinctly different from the prior art, which has typically approached formulation of confectionery fat compositions with an end of achieving an SFC curve that resembles tempered cocoa butter. These curves are exemplified by Fats A and B in FIG. 1, which have reasonably high solid fat contents at room temperature (20° C.) and a much lower solid fat content, perhaps less than 20% near body temperature (35° C.). Thus, despite having less solid fat content as measured by SFC (e.g., by AOCS Official Method Cd 16b-93), the fats of the invention set up to solids essentially as rapidly as the commercial fat. Despite having lower saturated fat, the invention exhibits enough rigidity and structure to perform acceptably in a compound coating. The melting curve for fat C made in accord with the invention has a far different shape, as portrayed in FIG. 1, but still functions well as a coating fat. Reference is also made to FIG. 2, which is a graph of solid fat formation in coating fats and compares a fat of the invention (--▴--) containing only 40% saturated fatty acids versus a commercial fat (--▪--) with about 98% saturates.

While the usual commercial confectionery fats have conformed to the melting curves shown for Fats A and B in FIG. 1, they also have a lot of solid fat at lower temperatures. The invention, which will be described in greater detail, is surprising in that it provides rapid set up to structurally stable form with very little saturated or trans fatty acids.

The work resulting in the present invention, questioned the need for the very high solids contents of the prior art. And, as research was conducted, it surprisingly turned out that not all solids of conventional confectionery coating fats are necessary for rapid set up, structural strength or appearance at room temperature. It was especially surprising that good confectionery coating properties could still be achieved with large amounts of saturated fatty acids being replaced with unsaturated fatty acids provided from liquid triglyceride oils. However, it was not the case that any fat with lower saturates and lower SFCs made a satisfactory coating.

Significantly, while the addition of large amounts of liquid oil will immediately and significantly reduce the quality of solid fat present in the coating fat at a given temperature. The formulations of the invention show a remarkable ability to retain properties important to confectionery coatings, e.g., rapid set up to a structurally integral form and good appearance such as gloss, while not being restricted to generally-accepted formulation criteria that require high saturated fatty acid contents. It was found that the invention enabled a structuring agent to enhance the desired nutrition of confectionery coatings by enabling more unsaturates and less saturates.

The confectionery fat compositions of the invention achieve good properties expected of confectionery coating fats despite having very low solids at 20° C. and having an SFC curve with little variation in slope from room temperature (e.g., 20° C.) to body temperature (e.g., 35° C.). To achieve this, a structuring agent is employed to hold large amounts of liquid oil while conferring snap and other physical properties expected of a coating fat.

Surprisingly, good qualities are maintained even when fat blends are prepared from the confectionery coating fat compositions of the invention and include melt-enhancing or heat stability enhancing fats in amounts necessary to achieve the effect of the added fats.

In embodiments, melt enhancing fats are added in amounts up to 70%, e.g., from 20 to 55%, to provide a confectionery fat blend. The melt enhancing fats are distinguished from the liquid triglyceride oils as having a melt point above 20° C. Among the suitable melt enhancing fats are one or more members selected from the group consisting of: palm kernel hard fractions, palm oil hard fractions, hydrogenated coconut oil, hydrogenated palm kernel oil, hydrogenated palm kernel hard fractions, hydrogenated palm oil hard fractions, and the like. Desirably, hydrogenated fats employed as melt enhancing fats should contain low amounts of trans fats (e.g., less than about 2%). The addition of these melt-enhancing fats in some embodiments can improve flavor release and/or meltaway properties for some confectionery coating applications when used in effective amounts.

In embodiments, other functional additives, e.g., heat stability increasing fats, may be employed in minor amounts, e.g., comprising up to about 6% of the total confectionery coating fat composition. Palm stearine with an IV of less than 15, an interesterified blend of shea stearine and palm stearine, hydrogenated palm oil hard fractions, and diglycerides. These additives in confectionery fat blends can increase heat stability.

The structuring agent employed in the confectionery fat compositions of the invention comprises an interesterified blend of highly saturated fats rich in the following fatty acids: lauric, myristic, palmitic, and stearic. In some embodiments palm stearine and palm kernel stearine are blended and interesterified to provide an interesterified blend of highly saturated fats rich in the following fatty acids: lauric, myristic and palmitic. The structuring agent can be blended with one or several liquid oils in amounts that provide compositions having good confectionery coating fat properties and significantly lower saturates compared to a typical cocoa butter alternative. The interesterification of the fat components of the structural fat, e.g., blends of highly saturated fats or fat fractions, such as palm stearine and the palm kernel stearine, randomizes the fatty acids among the triglycerides. The components are blended prior to being interesterified by processes as is known in the art, typically chemical or enzymatic interesterification. Chemical interesterification is a chemically-catalyzed ester exchange that results in the “shuffling” of fatty acids within a single triglyceride molecule and among triglyceride molecules until an equilibrium is achieved in which all possible triglyceride combinations are formed. Chemical interesterification results in a complete randomization of acyl groups in the triglycerides and can be employed as an alkaline-catalyzed chemical interesterification. The process may also be conducted through enzymatic-catalyzed interesterification, described for example in Bailey's Industrial Oil and Fat Products, sixth edition (Shahidi, F. 2005; Modification of Fats and Oils via Chemical and Enzymatic Methods Bailey's Industrial Oil and Fat Products.)

As noted above, the compositions of the invention exhibit properties important to coatings, e.g., rapid set up to structurally integral form, and good appearance such as gloss retention and resistance to oil off or smearing, while not being restricted to generally-accepted formulation criteria that require high saturated fat contents. According to the invention, a structurally integral form is one which is self-sustaining under its own weight at room temperature. In some embodiments, the compositions of the invention will provide good “snap” and also have good properties of “set-up”, “gloss”, “bloom resistance” and “appearance”. These terms have accepted meanings and are defined in objective terms for purposes of the invention.

The quality of “set up” in compound coatings is familiar to confectionery fat experts, and indicates the rate at which a coating goes from a liquid melt to a solid. In ordinary terms, a solid does not flow. An example of set up of a coating is enrobing, wherein a molten coating composition is poured over a food substrate held on a wire rack to permit excess to flow off. The coating is applied, for example, at a coating temperature of 50 to 55° C. and a substrate temperature of 20 to 25° C., and the time until the coating does not smear when touched lightly with a finger is measured and recorded. Some embodiments will be fully set in less than 20 minutes, with others being set in less than 10 minutes, under cooling conditions (e.g., 10° C.). Lesser times are achievable and may be desired in some applications. Generally, as a replacement for formulations now in use, it is desirable to match the set up time for the fat of the invention with what the prior application was achieving.

The property of “gloss” refers to a characteristic of the visual appearance of compound coatings, considered important for consumer acceptance, and refers to the ability of the surface of a chocolate product to reflect incident light giving a “shiny” or “glossy” appearance. Gloss can be measured in a variety of ways both visually and instrumentally. Sensory evaluation is often implemented for gloss determination of the confectionery coatings. Confectionery coating samples are analyzed by trained panelists for the sensory attribute of gloss using a 15 cm Quantitative Descriptive Analysis (QDA) scale. The intensity of the gloss attribute is then quantified giving an average value of gloss. Gloss values of 0 are deemed dull or have a matte finish and gloss values of 15 are deemed extremely glossy or shiny. Based on this procedure we find gloss values of between 2.0 and 4.0 are deemed acceptable, between 4.0 to 5.0 are deemed good, with values of 5.0 to 15.0 deemed desirable for many confectionery products. Alternatively, gloss data can be determined using the Tricor Glossmeter, e.g., Model 801A. Samples to be measured are held in a holder in the instrument's measurement chamber such that the surface to be measured is at the same level relative to the light source and camera for all products. The meter is calibrated prior to each use using the Tricor Gloss standard reference plate, which has a defined gloss level of 255. The measurement evaluated is the average gloss of the 5% brightest pixels with a threshold of 1. Typical subjective evaluations related to Tricor measured gloss values are as follows:

| Subjective | Gloss Reading |
|---|---|
| Excellent | >190 |
| Good | 175 to 189 |
| Fair | 160 to 174 |
| Min. Acceptable | 150 |
| Poor | 149 and below |

The property of “appearance” of confectionery coatings can be tested by a procedure which involves scoring for homogeneity of color, absence of mottling, stippling, cracks and air bubbles, each on a five-point scale, with excellent products of similar formulation being 4 and a wholly unacceptable product being 1. Based on this procedure we find that values of at least 3, e.g., from 3.25 to 4.0 are deemed good, with values above 3.5 meeting the appearance needs for most products.

The quality of “snap” is familiar to confectionery fat experts, and relates to both the force required to break a tablet of coating or coating fat and a lack of flexibility in a given piece of coating or coating fat. Typically, a sample of predetermined size is positioned between two supports and tested for fracture at a defined temperature by pressing down on the sample from above on a line midway between the two supports. Snap can be easily tested by a three-point bend test, which tests the stress at fracture of a sample of particular dimensions that has been conditioned in a defined way. In testing the products according to the invention, we used the procedure outlined in Example 2; and we adopt this test as the measure of snap. The numbers are reproducible when this procedure is followed, and the numerical values we use to describe snap must be viewed as determined by this procedure. For a quantitative measurement, a Texture Analyzer equipment (Stable Micro Systems, United Kingdom) and the 3-point bend rig (Texture Technologies, Scarsdale, N.Y.) has been employed. Uniform 11-gram tablets of dimensions 3.5×5.5×0.5 cm were poured, chilled, and permitted to crystallize for at least 24 hours at ambient temperature (approximately 21° C.).

The compositions, due to their formulations, are also characterized as being low in saturated fat and trans fat.

The term “saturated fat” is meant to refer to fats having no unsaturation. Included are those with from 4 to 22 carbons. The following saturated fatty acids will predominate but need not be present in the amounts generally thought by the prior art to be necessary: lauric acid (12:0), myristic acid (14:0), palmitic acid (16:0), and stearic acid (18:0). In some embodiments, the compositions of the invention will contain at least about 80%, say more than 90% (by weight), of saturated fatty acids present as C:12 to C:18 fatty acids. Thus, while the overall saturated fatty acid content of the fats of the invention will be low compared to any other cocoa butter alternative, those present can be predominantly within this narrow range of C:12 to C:18. In the case where the structuring agent is based on palm and palm kernel fractions, stearic acid and higher carbon fatty acids can be held to very minor amounts. The products of the invention are of the form where a relatively small amount of saturated fat entrains large amounts of oil. The design of the structuring agent within these guidelines can provide exceptional results for confectionery coatings with low amounts of saturated fat.

The terms “trans fatty acids” and “trans unsaturated fatty acids” as used in this description will mean the same thing, namely that the fatty acids discussed have an unsaturation wherein hydrogen substituents are on opposite sides of an associated double bond (trans configuration) as opposed to the cis configuration appearing in nature wherein these same hydrogen constituents are on the same side. The presence of the trans fatty acids is typically the result of partial hydrogenation and can occur, due to the action of the hydrogenation catalyst, during the hydrogenation process at double bonds. It is an advantage of the invention that hydrogenated fats are not required and, therefore, the total elimination of trans unsaturation is possible.

Thus, from another perspective, the products of the invention comprise a sufficient amount of a structuring agent comprised of an interesterified blend of palm stearine and palm kernel stearine, which is blended with a suitable liquid oil to provide fat compositions suitable for use in the preparation of confectionery coatings, substantially free of trans fatty acids, yet exhibit good properties of “set-up”, “gloss”, “bloom resistance” and “appearance”, with “snap” being achieved as necessary. In this context, the term “substantially free of trans fatty acids” means that a non-health threatening level of trans fatty acids is permitted. For example, such a level may range up to an amount at or below a level that meets labeling requirements as “trans free”. It is surprising that the confectionery fats of the invention contain less solid fat and a significant amount of liquid oil than typical confectionery coating fats yet yield similar textural characteristics such as rapid set up to structurally stable form. Blends of oils, additions of other stearines, and the use of structuring agents, other fats, and additives in addition to the type of structuring agent described in this description may be employed to improve the heat stability, viscosity, level of saturated fat, cost, or other attributes of the coating fat as desired.

As noted, a structuring agent employed according to the invention can be prepared from an interesterified blend made from a non-lauric fat, e.g., a stearine such as palm stearine, and a lauric fat, e.g., a stearine such as palm kernel stearine, both of low iodine values.

A palm stearine suitable for this invention will have very little trans unsaturation because it is not hydrogenated. However, while it may contain some trans fatty acids by the usual methods of analysis, it is typically under 2%. Ranges for properties of palm stearines of use in the invention will generally comprise from about 75 to about 85% palmitic acid, from about 0 to about 3% myristic acid and from about 0 to about 2% lauric acid, and an iodine value of less than about 18, e.g., from 1 to 12. In an embodiment, palm stearines can have an iodine value of less than about 12, e.g., from about 5 to 12.

Palm kernel stearine also will have very little trans unsaturation. And, while it may contain some trans fatty acids by the usual methods of analysis, it is preferably well under 1%. Ranges for properties of palm kernel stearines of use in the invention will generally comprise from about 7 to about 10% palmitic acid, from about 18 to about 25% myristic acid and from about 50 to about 60% lauric acid, and an iodine value of less than about 10. In an embodiment, palm kernel stearines can have an iodine value of less than 8, e.g., from about 4 to 8.

The liquid oil employed according to the invention is any suitable oil for confectionery use. Suitable oils may be chosen because of their low saturates, availability, cost, or other attributes as deemed desirable by the blender, user, consumer, and so on. The oil will also desirably have very little or be essentially free of trans unsaturation. The liquid oil may be, but is not limited to, Canola or sunflower oil, since they have on average only 6% and 9% saturated fat respectively. In some embodiments the liquid triglyceride oil is one or more selected from the group consisting of Canola oil, corn oil, cottonseed oil, high oleic soybean oil, marine oils, meadowfoam oil, mustard seed oil, olive oil, peanut oil, poppy seed oil, rice bran oil, safflower oil, sesame, soybean oil, sunflower oil, high oleic sunflower oil, low melting fractions of fats such as babassu nut oil, palm oil, palm kernel oil, tallow, lard, shea butter, dairy butter, and the like. For some commercially-important coating applications, the oil will comprise a highly stable oil with low saturates and low polyunsaturates (e.g., high oleic sunflower oil) with less than about 10% saturated fatty acids and less than 8% polyunsaturated fatty acids. In many products the liquid oil will have a total saturated fatty acid content of less than 10%, e.g., less than 8%, and will contain low levels of polyunsaturated fatty acids, e.g., less than 8%, or less than 6% PUFA.

The confectionery coating fat composition comprises a blend of: a structuring agent comprising an interesterified blend of palm stearine and palm kernel stearine; and a liquid triglyceride oil in proportions that provide good properties of “set-up”, “gloss” and “appearance” and in embodiments exhibit satisfactory “snap”.

In an embodiment, the structuring agent can comprise from 35 to 80%, preferably 40 to 65% of the total confectionery coating fat composition. In others, the structuring agent can comprise from 37 to 70%, e.g., from 40 to 65%, of the total confectionery coating fat com position.

In an embodiment, a confectionery coating fat composition will from 20 to 65%, preferably 35 to 60% of a liquid triglyceride oil.

In embodiments, the saturated fatty acids can comprise from 35 to 80%, e.g., from 40 to 70%, of a total confectionery coating fat composition or confectionary fat blend. In some embodiments less than 60% saturated fatty acids will be present.

In embodiments, a structuring agent will comprise an interesterified blend of palm stearine and palm kernel stearine, wherein the blend contains at least 90% of the saturated fatty acids present as lauric, myristic and palmitic acids.

In embodiments where the structuring agent is based on palm and palm kernel stearines, the structuring agent may contain as little as 30% to as much as 75%, e.g., 55 to 70%, of palm stearine interesterified with from 25 to 70%, e.g., 30 to 45% palm kernel stearine. Each of the components that are blended to form the structuring agent will have low iodine values. For many applications the structuring agent from about 35 to about 80%, e.g., 37 to 65%, or 40 to 60%, of the confectionery coating fat composition and the liquid oil will comprise from 65 to 20%, e.g., from 63 to 35%, or 60 to 40%. In some cases, it is desirable to prepare a blend with lower amounts of liquid oil for transportation and then blend locally at the point of use with a liquid oil of choice.

The confectionery coating fat composition of the invention compares favorably to other confectionery fats. Whereas it contains a high proportion of liquid oil and does not require tempering, it is fully functional in making coatings for a wide variety of confectionery and bakery products, and can provide coatings with surprisingly good snap and other characteristics. A principal purpose of the invention is to provide confectionery coating fat compositions and confectionery coating fat blends which can have less saturated fatty acids than most confectionery fats, e.g., as low as 35%, and typically containing from about 40 to about 70%, saturated fat. The confectionery coating fat blends can be useful for some applications with saturated fatty acid contents of as high as 80%. And, it may be prepared in such a way that the coating fat is essentially trans fatty acid free and can be non-hydrogenated.

The coating fat can be easily blended with typical coating ingredients to form coating compositions, which typically comprise the coating fat, sugar or other sweetener, optionally cocoa powder and flavoring in reasonable proportions. For use as coatings for candy bars, the coating composition will typically comprise a fine grind sugar, e.g., with particle sizes of from 20 to 45 μm for many coatings of this type. In addition to flavors such as vanilla, vanilla extract, vanillin, cinnamon, and the like, cocoa powder is a typical ingredient contributing chocolate flavor. Cocoa powder is used in amounts of up to about 25% by weight of a coating, which is far higher than the more concentrated flavors that may also be used.

Embodiments intended for coatings on dough-based products, such as cookies and freshly-baked products, e.g., donuts, will employ the above criteria. Depending on the final characteristics of the coatings, some embodiments may contain more sugar or other ingredient.

For some products, sugar will be present in an amount of from about 35 to about 55%, the fat will be present in an amount of from about 24 to about 35% and one or more flavors will be employed in low amounts for concentrated flavors and to about 20% for cocoa powder, all percentages being by weight of the total composition. Where sugar substitutes or sugars other than sucrose, the criteria would call for matching the desired sweetness of sucrose and adjusting the solids accordingly, in some cases adding a bulking agent such as polydextrose, or the like.

The coating compositions of the invention will be applied to all of those food products for which fat-based coatings are now applied using standard enrobing equipment. It is an advantage for embodiments that applied coatings can provide good properties of “set-up”, “rigidity”, “gloss”, “bloom” and “appearance” are non-tempering and for embodiments can exhibit good “snap”.

The following examples are presented to further explain and illustrate the invention and are not to be taken as limiting in any regard. Unless otherwise indicated, all parts and percentages are by weight here and in the above description. These examples demonstrate that the invention provides improvements in coating fats, especially for confectionery uses, which enable the production of high quality coatings without the need for the high fat solids contents or hydrogenation as taught generally to the art.

The typical enrobing process entails heating the coating fat to obtain a molten suspension, e.g., at a temperature of from 40° to 60° C., pouring the coating composition over a food substrate and then cooling the coated product in a cooling tunnel (e.g., 10° C.).

The following examples are presented to further illustrate and explain the invention and are not to be taken as limiting in any regard. Unless otherwise indicated, all parts and percentages are by weight based on the product or formulation at the indicated stage of processing.

### EXAMPLE 1

This example describes the preparation of a coating fat composition by blending a liquid oil with a structuring agent comprising an interesterified blend of 35 parts of palm kernel stearine and 65 parts of palm stearine of the following characteristics:

| | Palm Kernel | |
|---|---|---|
| | Stearine | Palm Stearine |
| IV | 4 | 12 |
| C8:0 | 1.9 | 0.0 |
| C10:0 | 3.0 | 0.0 |
| C12:0 | 55.3 | 0.2 |
| C14:0 | 23.3 | 1.3 |
| C16:0 | 8.9 | 81.6 |
| C18:0 | 2.0 | 5.1 |
| C18:1 | 4.9 | 9.7 |
| C18:2 | 0.7 | 2.1 |
| SATS | 94.4 | 88.2 |

Then, 61 parts of high-oleic sunflower oil were blended with only 39 parts of the structuring agent. This product was blended with sugar and flavoring to provide an excellent donut coating while having a saturated fatty acid content of only 40%.

### EXAMPLE 2

This example describes the preparation of a coating fat composition by blending a liquid oil (high oleic sunflower oil) with a structuring agent comprising an interesterified blend of 35 parts of palm kernel stearine, 4 IV, and 65 parts of palm stearine, 12 IV. The structuring agent was used at a level of 55%, and the liquid oil was used at 45%, to provide a coating fat having 56% total saturated fats. This product was incorporated into a good, brittle coating by a typical formula and was used with success to coat cookies and other products.

| | Structuring | Liquid Oil | Coating Fat |
|---|---|---|---|
| | Agent | HOSFO | Composition |
| C8:0 | 0.6 | — | 0.3 |
| C10:0 | 0.9 | — | 0.5 |
| C12:0 | 19.6 | — | 10.8 |
| C14:0 | 8.8 | — | 4.8 |
| C16:0 | 58.9 | 3.7 | 35.9 |
| C18:0 | 3.5 | 3.2 | 3.7 |
| C18:1 | 7.3 | 86.7 | 36.3 |
| C18:2 | 0.5 | 5.9 | 7.7 |
| C18:3 | — | 0.5 | — |
| SATS | 92.2 | 6.9 | 56.0 |

A confectionery coating utilizing the above coating fat composition is tested for snap as follows: The procedure to determine “snap” is as follows:
1) Samples are prepared by heating the test composition to a temperature of 55° C. and holding it at this temperature for 60 minutes.
2) Pouring the test composition into molds having the following dimensions: width 31 mm, length 53 mm and depth 4 mm, and scraping the top surface to assure uniform thickness.
3) The molds were then cooled at 4° C. for 1 hour.
4) The samples were then demolded and held in an environment of temperature 21°±1° C. to await testing.
5) Each sample is tested by using a Stable Micro Systems TA.XT Express Texture Analyzer, which has a 5 kg·f capacity in compression and tension with a measurement resolution of better than 0.1 g. It has a speed range 0.1-10.00 mm/s and a stroke of 0.1-135 mm. Lower, knife-edge supports are spaced at a distance of 30 mm, and an upper knife-edge probe is positioned at the midpoint of the samples prior to causing the upper probe to move downwardly while the applied force is measured.
6) The stress at fracture is calculated from the applied force at the time of fracture by the internal software, which applies the formula of σ=1.5 P/wt², where σ is stress at fracture, P is the load applied in Newtons, t is the thickness of the sample (meters), w is the width of the sample (meters), and 1 is the supported length of the sample (meters).

Based on this measure the snap was 2100 g/sec. In other tests of confectionery coatings of other embodiments of the invention, we find that values of at least 800 g/sec., e.g., from 1500 to 3000 g/sec. are deemed preferable, with values of from 800 to 2400 g/sec. being acceptable for many products.

### EXAMPLE 3

This example describes the preparation of a confectionery coating fat composition made from a structuring agent comprising an interesterified blend of 60 parts of palm stearin and 40 parts of palm kernel stearine and a liquid oil (Canola oil). The two components were blended 61% and 39% respectively to obtain a saturated fat level of 60.5%. This product was incorporated into a typical confectionery coating formula.

| | Structuring | Coating Fat |
|---|---|---|
| | Agent | Composition |
| Iodine Value | 9.3 | 48.7 |
| Mettler Drop Point (F.) | 115.1 | 109.2 |
| C8:0 | 0.6 | 0.4 |
| C10:0 | 1.0 | 0.6 |
| C12:0 | 22.8 | 14.1 |
| C14:0 | 10.0 | 6.5 |
| C16:0 | 54.9 | 36.0 |
| C18:0 | 3.3 | 2.9 |
| C18:1 | 6.5 | 28.6 |
| C18:2 | 0.9 | 8.2 |
| C18:3 | — | 2.6 |
| Saturated Fat (%) | 92.6 | 60.5 |
| Monounsaturated Fat (%) | 6.5 | 28.6 |
| Polyunsaturated Fat (%) | 0.9 | 10.9 |

The above fat composition was used in a typical confectionery coating formulation and was tested for snap following the procedure previously provided. Based on this measure, the average snap was desirable at 2961 g/sec.

Sensory evaluation was implemented for initial gloss determination of the confectionery coating. Animal crackers were enrobed with the above confectionery coating. Samples were allowed to equilibrate to room temperature (20° C.) for 24 hours. The samples were analyzed by trained panelists for the sensory attribute of gloss using a 15 cm Quantitative Descriptive Analysis (QDA) scale. The intensity of the gloss attribute is then quantified giving an average value of gloss for the confectionery coating. Gloss values of 0 are deemed dull or have a matte finish and gloss values of 15 are deemed extremely glossy or shiny. Based on this measure, the initial gloss value of the confectionery coating containing the above composition was 7.7. Based on this procedure we find gloss values of between 2.0 and 4.0 are deemed acceptable, between 4.0 to 5.0 are deemed good, with values of 5.0 to 15.0 deemed desired for many products.

The property of “appearance” of the confectionery coating was tested by scoring for homogeneity of color, absence of mottling, stippling, cracks and air bubbles, each on a five point scale, with excellent products of similar formulation being 4 and a wholly unacceptable product being 1. Based on this procedure we find that values of at least 3, e.g., from 3.25 to 4.0 are deemed good, with values above 3.5 meeting the appearance needs for most products. Based on this measure, the appearance of a confectionery coating made with the above composition was scored as 3.9.

### EXAMPLE 4

This example describes the preparation of a coating fat composition comprising a structuring agent comprising an interesterified blend of 35 parts of palm stearin and 65 parts of palm kernel stearine and a liquid oil (Canola oil). The liquid oil was used at 40% and the structuring agent was used at 60% to provide a coating fat with 61.5% saturated fat. This product was incorporated into a typical coating formula.

| | Structuring | Coating Fat |
|---|---|---|
| | Agent | Composition |
| Iodine Value | 7.4 | 48.8 |
| Mettler Drop Point (F.) | 104 | 97.8 |
| C8:0 | 0.9 | 0.6 |
| C10:0 | 1.6 | 1.0 |
| C12:0 | 36.3 | 23.4 |
| C14:0 | 15.9 | 10.1 |
| C16:0 | 35.6 | 24.2 |
| C18:0 | 2.8 | 2.2 |
| C18:1 | 5.9 | 27.9 |
| C18:2 | 1.0 | 8.4 |
| C18:3 | — | 2.3 |
| Saturated Fat (%) | 93.1 | 61.5 |
| Monounsaturated Fat (%) | 5.9 | 27.9 |
| Polyunsaturated Fat (%) | 1.0 | 10.7 |

This composition was used in a typical confectionery coating formulation and was tested for snap, initial gloss and appearance following the procedures previously provided. Based on this measure, the average snap was desirable at 1096 g/sec. The initial gloss value was desirable at 7.3 and the appearance was deemed excellent at 4.0.

### EXAMPLE 5

This example describes the preparation of a confectionery coating fat composition made from a structuring agent comprising an interesterified blend of 65 parts of palm stearin and 35 parts of palm kernel stearine and a liquid oil (Canola oil). The two components were blended 39% and 61% respectively to obtain a saturated fat level of 40%. Sixty-five percent of this coating fat composition was then blended with 35% of a hydrogenated palm kernel oil hard fraction to provide a blend composition with enhanced organoleptic properties and texture in a confectionery coating. This confectionery coating fat blend had a saturated fat level of 62.1%. This product was incorporated into a typical confectionery coating formula.

| | Coating Fat |
|---|---|
| | Composition |
| Iodine Value | 46.6 |
| Mettler Drop Point (F.) | 103.4 |
| C8:0 | 0.9 |
| C10:0 | 1.3 |
| C12:0 | 24.8 |
| C14:0 | 10.1 |
| C16:0 | 19.9 |
| C18:0 | 5.1 |
| C18:1 | 26.8 |
| C18:2 | 8.6 |
| C18:3 | 2.6 |
| Saturated Fat (%) | 62.1 |
| Monounsaturated Fat (%) | 26.8 |
| Polyunsaturated Fat (%) | 11.1 |

This composition was used in a typical confectionery coating formulation and was tested for snap, initial gloss and appearance following the procedures previously provided. Based on this measure, the average snap was acceptable at 1067 g/sec. The initial gloss value was desirable at 6.8 and the appearance was deemed excellent at 3.25.

Alternative compositions and processes employing those described above can include the disclosed features and incorporate alternative aspects as necessary for a wide variety of applications.

The above description is for the purpose of teaching the person of ordinary skill in the art how to practice the invention. It is not intended to detail all of those obvious modifications and variations, which will become apparent to the skilled worker upon reading the description. It is intended, however, that all such obvious modifications and variations be included within the scope of the invention which is defined by the following claims. The claims are meant to cover the claimed components and steps in any sequence which is effective to meet the objectives there intended, unless the context specifically indicates the contrary.

What is claimed is:

1. A low SAFA confectionery coating fat composition for preparing coatings that rapidly set up to structurally stable form, comprising a blend of:
a. a structuring agent comprising an interesterified blend of palm stearine and palm kernel stearine; and
b. a liquid triglyceride oil.

2. A confectionery coating fat composition according to claim 1, wherein structuring agent comprises an interesterified blend comprising 30 to 75% of palm stearine having an iodine value of less than 18 and from 25 to 70% palm kernel stearine having an iodine value of less than 10.

3. A confectionery coating fat according to claim 1, wherein the structuring agent comprises at least 90% of the saturated fatty acids present as lauric, myristic, palmitic and stearic acids.

4. A confectionery coating fat according to claim 1, wherein the structuring agent is present in an amount of from 35 to 80% of the coating fat.

5. A confectionery coating fat according to claim 4, wherein the structuring agent is present in an amount of from 40 to 65% of the coating fat.

6. A confectionery coating fat according to claim 1, wherein the liquid triglyceride oil is present in an amount of from 20 to 65% of the coating fat.

7. A confectionery coating fat according to claim 6, wherein the liquid triglyceride oil is present in an amount of from 35 to 60% of the coating fat.

8. A confectionery coating fat according to claim 1, wherein the liquid triglyceride oil is one or more selected from the group consisting of Canola oil, corn oil, cottonseed oil, marine oils, meadowfoam oil, mustard seed oil, olive oil, peanut oil, poppy seed oil, rice bran oil, safflower oil, sesame, soybean oil, high oleic soybean oil, sunflower oil, high oleic sunflower oil, low melting fractions of fats such as babassu nut oil, palm oil, palm kernel oil, tallow, lard, shea butter, milk fat, and the like.

9. A confectionery coating fat according to claim 8, wherein the liquid triglyceride oil is selected from the group consisting of Canola oil, high oleic soybean oil and high oleic sunflower oil.

10. A confectionery coating fat according to claim 1, wherein the liquid triglyceride oil has a saturated fatty acid content of less than 10% and less than 8% polyunsaturated fatty acids.

11. A confectionery fat blend comprising the confectionery coating fat compostion according to claim 1, wherein the saturated fat is present in an amount of 35 to 80% of the coating fat.

12. A confectionery fat blend comprising the confectionery coating fat according to claim 1, comprising up to 70% of a melt-enhancing or heat stability enhancing fat in amounts necessary to achieve the effect of the added fat or fats.

13. A confectionery fat blend comprising the confectionery coating fat according to claim 1, wherein the fats in the coating comprise melt enhancing fat selected from the group consisting of: palm kernel hard fractions, palm oil hard fractions, hydrogenated coconut oil, hydrogenated palm kernel oil, hydrogenated palm kernel hard fractions, hydrogenated palm oil hard fractions and the like and mixtures of one or more of them.

14. A confectionery fat blend according to claim 13, wherein the melt enhancing fat comprises a hydrogenated fat containing less than 2% trans fats.

15. A confectionery fat blend comprising the confectionery coating fat according to claim 1, which further comprises heat stability additives in amounts up to 6% of the total confectionery coating fat composition, the additives being selected from the group consisting of palm stearine with an IV of less than 15, an interesterified blend of shea stearine and palm stearine, hydrogenated palm oil hard fractions, and diglycerides, in amounts effective to increase the heat stability of the coatings prepared with the fat.

16. A confectionery coating fat composition according to claim 1, wherein:
a. the structuring agent is present in an amount of from 35 to 80% of the confectionery coating fat composition;
b. the structuring agent comprises an interesterified blend comprising 30 to 75% of palm stearine having an iodine value of less than 18 and from 25 to 70% palm kernel stearine having an iodine value of less than 10, and comprises at least 90% of the saturated fatty acids present as lauric, myristic, palmitic and stearic acids;
c. the liquid triglyceride oil is present in an amount of from 20 to 65% of the coating fat; the liquid triglyceride oil comprises a member selected from the group consisting of Canola oil, corn oil, cottonseed oil, marine oils, meadowfoam oil, mustard seed oil, olive oil, peanut oil, poppy seed oil, rice bran oil, safflower oil, sesame, soybean oil, high oleic soybean oil, sunflower oil, high oleic sunflower oil, low melting fractions of fats such as babassu nut oil, palm oil, palm kernel oil, tallow, lard, shea butter, milk fat and mixtures of these; and
d. the liquid triglyceride oil has a saturated fatty acid content of less than 10% and less than 8% polyunsaturated fatty acids.

17. A confectionery fat blend comprising the confectionery coating fat composition according to claim 16, wherein the saturated fat is present in an amount of 35 to 80% of the coating fat.

18. A confectionery fat blend comprising the confectionery coating fat according to claim 16, comprising up to 70% of a melt-enhancing or heat stability enhancing fat in amounts necessary to achieve the effect of the added fat or fats.

19. A confectionery fat blend comprising the confectionery coating fat according to claim 16, wherein the fats in the coating comprise melt enhancing fat selected from the group consisting of: palm kernel hard fractions, palm oil hard fractions, hydrogenated coconut oil, hydrogenated palm kernel oil, hydrogenated palm kernel hard fractions, hydrogenated palm oil hard fractions and the like and mixtures of one or more of them.

20. A confectionery fat blend according to claim 19, wherein the melt enhancing fat comprises a hydrogenated fat containing less than 2% trans fats.
